(19) United States
(12) Patent Application Publication
(10) Pub. No.: US 2015/0247110 A1
(43) Pub. Date: Sep. 3, 2015

(54) BEVERAGE INFUSING AND DISPENSING DEVICE

(71) Applicant: Andale Repetition Engineering Pty Ltd., Airport West Victoria (AU)

(72) Inventor: MATTHEW JAMES DALE, Airport West Victoria (AU)

(73) Assignee: Andale Repetition Engineering Pty Ltd., Airport West Victoria (AU)

(21) Appl. No.: 14/632,234

(22) Filed: Feb. 26, 2015

(30) Foreign Application Priority Data
Mar. 3, 2014 (AU) 2014900688

(51) Int. Cl. C12C 5/02

(52) U.S. Cl. CPC C12C 5/026

(57) ABSTRACT

The present invention relates generally to a beverage dispensing device for dispensing a beverage such as beer, and in particular, to a beverage dispensing device configured to be able to dispense a beverage and infuse the beverage with a flavor as part of the dispensing process.

### CROSS REFERENCE TO RELATED APPLICATIONS

This application relates to and claims priority from AU Provisional Pat. App. Ser. No. 2014900688 filed Mar. 3, 2014, the entire contents of which are incorporated herein by reference.

### FIGURE SELECTED FOR PUBLICATION

FIG. 1

### BACKGROUND OF THE INVENTION

1. Field of the Invention

The present invention relates generally to a beverage dispensing device for dispensing a beverage such as beer, and in particular, to a beverage dispensing device being configured for dispensing a beverage and infusing the beverage with a flavour as part of the dispensing process.

2. Description of the Related Art

Devices for dispensing beverages, such as beer, have been well established. Typically, draught beer is served in hotels and pubs and is served from a keg or cask, rather than from a bottle. The keg or cask is typically remotely located from the dispensing point, namely a beer font that consists of a beer tap and a dispensing handle. The beer is typically pressurised for delivery from the beer font and a variety of chilling systems have been developed to ensure that the beer dispensed from the tap of the beer font is at a desirable temperature.

Whilst draught beers are popular in pubs and clubs, there is limited opportunity to alter the taste of the beer prior to dispensing. In recent times there has been a growing trend for beer drinkers to move toward premium or boutique beer as an alternative to standard draught beers. Typically, boutique or premium beers are able to experiment with different tastes and flavours and may be crafted to enable infusing with a variety of different fruits and the like to enhance the flavour of the beverage and the overall drinking experience for the consumer.

Whilst the concept of infusing a beverage with fruits, herbs and the like has been well established, this is typically performed as a separate step in the process of production of the beverage. Many infused beers include the infusion process as part of the overall brewing process and as such, such beers are distributed to retailers for sale with the infusion process already performed. Alternatively, it is common for premium beers to be served with a slice of lemon or lime in order to enhance the flavour of the beer, and this is generally done by placing a slice of lemon or lime in the drink after dispensing the drink and immediately prior to consumption.

In recent times, the fonts for dispensing beers and other beverages in bars and hotels have become more visually and aesthetically appealing to improve the decor of the venue. In this regard, many fonts employ techniques to facilitate the formation of ice on the surfaces of the fonts or fonts may have distinctive shapes that are visually appealing and add to the overall aesthetics of the venue.

Thus, there is a need to provide a dispensing system for dispensing beer and other beverages that is able to be simply adapted to be used to infuse the beverage with a flavor as part of the dispensing process, preferably in a visually appealing manner.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### ASPECTS AND SUMMARY OF THE INVENTION

The invention according to one or more aspects is as defined in the independent claims. Some optional and/or preferred features of the invention are defined in the dependent claims.

Accordingly, in one aspect of the invention there is provided a beverage dispensing device including:
a body configured to receive a supply of beverage from a source and having a pouring means mounted thereto for dispensing said beverage; and
an infusion chamber mounted to said body, the infusion chamber defining an enclosed space for receiving one or more infusion products;
wherein, the infusion chamber is in fluid communication with said body so as to receive the supply of beverage therefrom such that the beverage passes through said infusion chamber prior to being dispensed from the pouring means.

In one embodiment, the enclosed space of the infusion chamber is able to be maintained at a substantially constant temperature and pressure.

A heat exchanger may be provided to enable the enclosed space of the infusion chamber to be maintained at or close to a predetermined temperature. The heat exchanger may be located wholly or partly within the body of the beverage dispending device and/or the infusion chamber mounted to said body. In one embodiment, the heat exchanger may extend within the infusion chamber. In another embodiment, the heat exchanger may extend within the body of the device. In a further embodiment, the heat exchanger may be associated with the body to chill the beverage prior to entering the infusion chamber. The heat exchanger may include one or more of a glycol plate, an ice bank chiller, the lines associated with said glycol plate or said ice bank chiller, an in-line heat exchanger, or another conventional heat exchanger known to the person skilled in the art.

The infusion chamber may include a tubular body made from a substantially transparent material.

The tubular body of the infusion chamber may be substantially cylindrical and may be mounted to the body of the dispensing device so as to be positioned above said body of the dispensing device.

The infusion chamber may receive the supply of beverage via a delivery pipe that projects from the body of the dispensing device to extend within the infusion chamber and terminate adjacent an upper region of the infusion chamber. The delivery pipe may substantially fill the infusion chamber with the beverage such that the beverage is maintained in the infusion chamber under pressure.

The body may have an outlet formed on an upper surface thereof for receiving the beverage present in the infusion chamber. The outlet may be in direct fluid communication with the pouring means such that the beverage can be dispensed from the pouring means under pressure.

The pouring means may be a tap, nozzle, valve, plug, spout or any combination of these other outlets suitable for pouring a beverage.

The infusion chamber may have a secondary pouring means to enable dispensing of the beverage directly from the infusion chamber, the secondary pouring means being located at or near an upper part of the infusion chamber. The infusion chamber optionally includes a pressure relief valve for releasing air pressure from the infusion chamber. The pressure relief valve may be a spring activated valve able to be pushed down to release air pressure from the infusion chamber. The pressure relief valve may be associated with a secondary pouring means to enable a portion of the beverage to be poured directly from the infusion chamber via the secondary pouring means when the pressure relief valve is activated.

The body of the dispensing device may be configured for installation on a bar, ledge or other platform suitable for beverage dispensing.

The body of the dispensing device may be configured for replacing an existing beverage dispensing font or being located beside an existing beverage dispensing font or fonts.

According to another aspect of the present invention, there is provided a method of infusing a flavour into a beverage to be dispensed from a dispensing device including:
loading an infusion chamber associated with the dispensing device with an infusing material;
supplying the beverage to the infusion chamber at a predetermined pressure and temperature to substantially fill the infusion chamber such that the infusion chamber is maintained at or close to said predetermined pressure and temperature; and
releasing the beverage from the infusion chamber to be dispensed for consumption therefrom.

In one embodiment of the method, the step of releasing the beverage includes opening a pouring means in fluid communication with the infusion chamber to facilitate dispensing of the beverage therefrom under the predetermined pressure.

The above and other aspects, features and advantages of the present invention will become apparent from the following description read in conjunction with the accompanying drawings, in which like reference numerals designate the same elements.

### BRIEF DESCRIPTION OF THE DRAWINGS

The invention may be better understood from the following non-limiting description of preferred embodiments, in which:

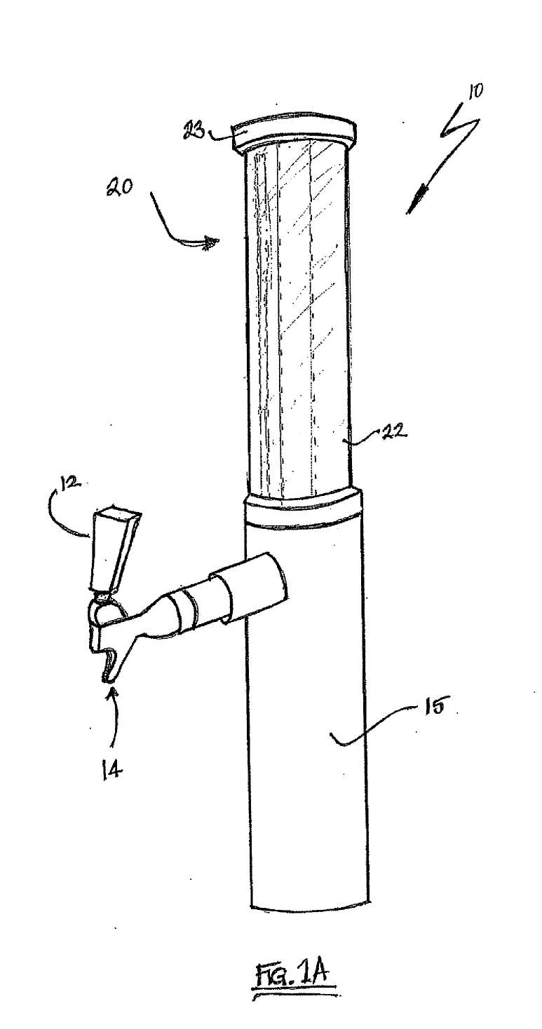

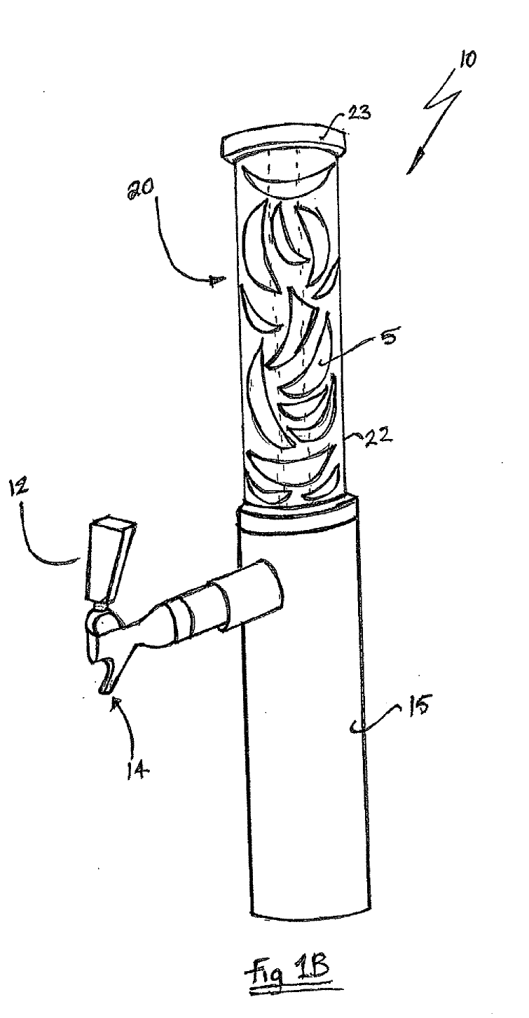

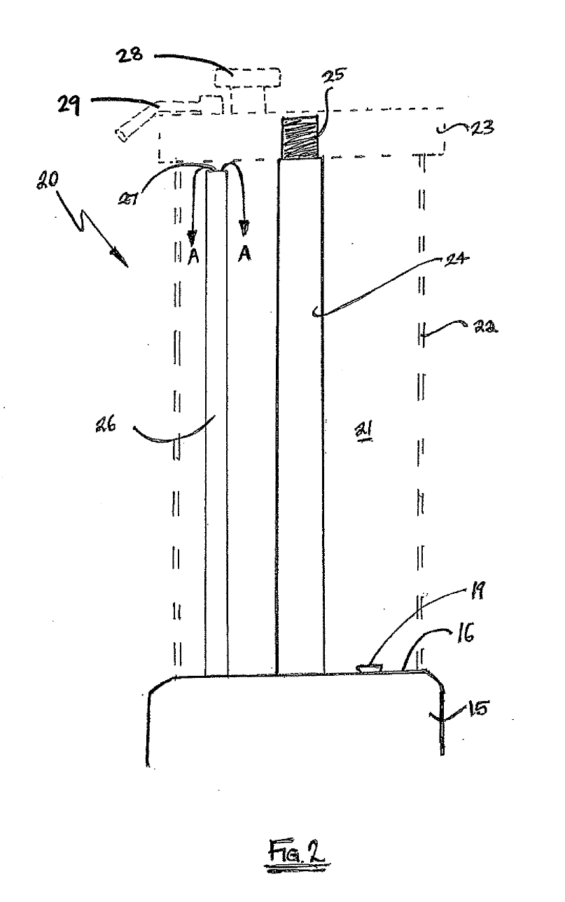

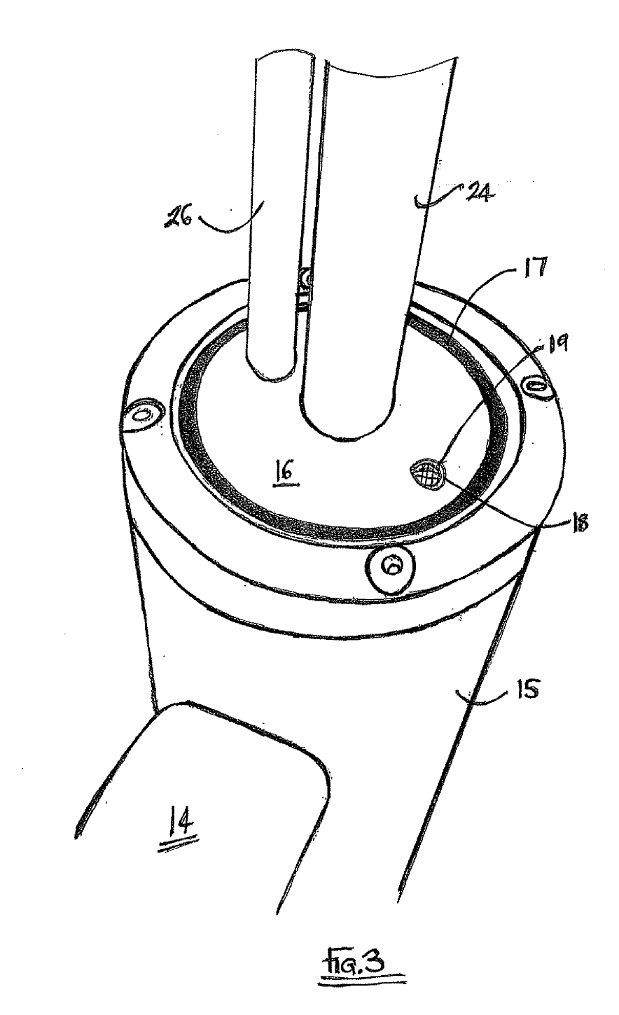

FIG. 1A is a front perspective view of the beverage dispensing device in accordance with an embodiment of the present invention being used in a standard manner.

FIG. 1B is a front perspective view of the beverage dispensing device of FIG. 1 being used in a flavor infusing manner.

FIG. 2 is a cross-sectional side view of the infusion chamber of the beverage dispensing device of FIGS. 1 and 2.

FIG. 3 is an enlarged view of a portion of the infusion chamber depicted in FIG. 2.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

* Preferred features of the present invention will now be described with particular reference to the accompanying drawings. However, it is to be understood that the features illustrated in and described with reference to the drawings are not to be construed as limiting on the scope of the invention.

Referring to FIGS. 1A and 1B, a beverage dispensing device 10 in accordance with a preferred embodiment of the present invention is shown. More particularly, FIG. 1A depicts a beverage dispensing device 10 where the infusion chamber 20 is filled with a beverage but does not have infusion products within the chamber. FIG. 2A depicts a beverage dispensing device 10 where the infusion chamber 20 is filled with a beverage and infusion products 5.

The present invention will be described in relation to the dispensing of beer, such as a draught beer. However, it will be appreciated that the present invention could be employed to dispense a variety of different types of beverages, such as cider, and non-alcoholic beverages, as will be appreciated by those skilled in the art.

The beer dispensing device, or font 10 generally includes a body 15 that is mounted on a bar or similar dedicated serving area such that the font is displayed in the manner as depicted in FIGS. 1A and 1B. The body 15 is generally in the form of a stainless steel cylindrical tube that houses one or more beer lines (not shown) therein for supplying the beer to the font 10. The body 15 or infusion chamber 20 may also incorporate a heat exchanging device (not shown) for chilling the beer present in the beer lines as the beverage passes through the body 15 or infusion chamber 20. The heat exchanging device may be a glycol plate, an ice bank chiller, the lines associated with said glycol plate or said ice bank chiller, an in-line heat exchanger, or another conventional heat exchanger. It will be appreciated that there exist a number of systems for supplying draught beer from a keg located remotely from the font 10 in a pressurized and chilled manner. Most modern beer supply systems employ beer pythons that include a beer line bundled with a coolant line to ensure that the beer is kept at a substantially constant temperature as it travels from the keg, or storage unit, to the beer tap. These systems also function to reduce the growth of wild yeasts and bacteria within the beer lines, thereby reducing the potential of beer wastage as a result.

Whether via a heat exchanging device or a beer python type beer delivery system, having a heat exchanger in close proximity to the infusion chamber is important to enable the beer in the chamber to be held at a substantially consistent temperature and pressure. This, in turn, is important for limiting foaming of the beer within the device and/or hindering the infusion process within the infusion chamber, which may result from fluctuating temperatures and pressures of the beverage in the device, or from the infusing material and the beverage being at different temperatures.

A beer tap 14 is mounted to the body 15 in the manner as shown. The beer tap operates as a pouring means. The beer tap 14 includes a handle 12 that is able to open the tap to facilitate dispensing of the beverage from the tap 14 in a controlled manner. In the embodiment of the present invention as shown, only one beer tap 14 is depicted. However, it will be appreciated that multiple taps 14 may be mounted to the body 15 as desired, with each tap 14 having a dedicated beer line for delivering beer thereto and each tap having a handle 12 to be operated independently to dispense beer therefrom.

An infusion chamber 20 is mounted to the upper region of the body 15, as shown. As will be discussed in more detail below, the infusion chamber 20 includes a clear and see-through tubular body 22 that may be made from a plastic or glass material with an end cap 23 sealing the distal end thereof. The infusion chamber 20 is able to be opened so as to be filled with fruit or any other material that enables the beer being dispensed by the font 10 to be infused with the material contained therein immediately prior to dispensing from the tap 14. FIG. 1B depicts the font 10 filled with fruit 5, such as lemons or limes to facilitate infusing of the beer being delivered with a citrus flavor in the manner to be described in more detail below. It will be appreciated that other materials may be used for infusing other flavors into the beer, as desired.

As is depicted in FIG. 2, the infusion chamber 20 generally includes an elongate cylindrical space 21 that is defined by the cylindrical body 22. The tubular body 22 is mounted to the upper surface 16 of the body 15 and a central pedestal 24 extends from the surface of the body 15 substantially centrally within the space 21. The pedestal 24 has a threaded distal end that is configured to engage with a complementary internally threaded recess provided in the end cap 23 such that the end cap 23 is able to be tightened to about the cylindrical body 22 to securely retain the cylindrical body 22 in position on the upper surface 16 of the body 15.

To ensure that the cylindrical body 22 is sealed at both its upper and lower ends, a seat is formed in both the underside of the end cap 23 (not shown) and the upper surface 16 of the body 15 to receive the ends of the cylindrical body 22. The seat 17 formed in the upper surface 16 of the body 15 is depicted in FIG. 3.

The seat 17 generally includes a circular groove or channel foamed in the upper surface 16 which receives a rubber ring or gasket. A similar arrangement may be formed in the underside of the end cap 23 such that as the end cap 23 is screwed into position on the end of the pedestal 24, pressure is placed on the ends of the cylindrical body 22 to form a watertight seal at either end with the rubber ring or gasket formed in the seat 17. In this regard, when the body 22 is secured in position in such a manner, the space 21 becomes a substantially sealed and airtight space.

Referring again to FIG. 2, a delivery pipe 26 also extends from the upper surface 16 of the body 15 to extend substantially parallel to the pedestal 24. The delivery pipe 26 has an open end 27 that terminates before the end of the pedestal such that the delivery pipe 26 is able to deliver beer into the space 21 from an upper region thereof, in the direction of arrow ‘A’. The other end of the delivery pipe 26 is in contact with the beer line (not shown) such that the beer is delivered into the space 21 under pressure and at a substantially constant delivery temperature. In this regard, the space 21 essentially fills with beer and is maintained at or close to the desired pressure such that the beer present in the space 21 is directly directed to the tap 14 for dispensing. To facilitate regulation of pressure within the space 21, a pressure relief valve 28 may be provided in the end cap 23 as shown.

The pressure relief valve 28 is a spring activated valve that can be pushed down to release air pressure from within the infusion chamber. The infusion chamber 20 further includes a secondary pouring means 29 associated with the pressure relief valve 28. The pouring means 29 is a curved pouring tube which extends from an upper part of the infusion chamber 20 and it is able to pour a portion of the beer directly from the infusion chamber when the pressure relief valve 28 is activated.

The manner in which the beer present in the space 21 of the infusion chamber 20 is directed to the tap 14 is shown in FIG. 3. In this regard, an outlet 18 is formed in the upper surface 16 of the body 15 which is directly connected to the tap 14 by way of a return tube (not shown). In this regard, as the tap 14 is opened, beer present in the return tube is delivered from the tap 14 which draws beer from the space 21 which is maintained at the desired delivery pressure and temperature. As the space 21 is pressurised, as the beer is consumed from the space 21 it is replaced by the beer present in the delivery pipe 26 which maintains the level of fluid in the space 21 at the desired pressure.

In accordance with the present invention, when the space 21 contains fruit 5 or other infusing material, the beer present in the space passes through the infusing material 5 as it passes from the open end 27 of the delivery pipe 26 to the outlet 18. This then enables the beer to be infused with the flavouring of the infusing material immediately prior to being dispensed from the tap 14. The amount of infusing material 5 present in the space 21 may vary in accordance with taste and flavouring requirements and as discussed previously, no infusing material needs to be present for the font 10 to function. If no infusing material 5 is used, the infusion chamber 20 will be filled with beer which will provide an interesting aesthetic effect, even without the presence of infusing material 5. Should infusing material 5 be used, a filter 19 may be provided over the outlet 18 to avoid any particulate material being dispensed from the tap 14, or entering the fluid line.

It will be appreciated that the temperature of the beer present in the infusion chamber 20 will be maintained at the desired delivery temperature due to the close proximity of the beverage with the heat exchanger and cooling lines provided with the beer delivery system. Should additional chilling or greater temperature control within the device be required, the pedestal 24 may comprise a hollow tube such that a coolant could be passed along inside the hollow tube of the pedestal 24 to provide additional chilling of the beer present in the infusion chamber 20. Alternatively, the coolant could be passed around the pedestal 24 by tubing carrying the coolant being wrapped around the pedestal.

By providing a heat exchanger, such as a chiller device associated with the font 10, the beverage and the infusing material is maintained in a chilled state thereby reducing the likelihood of foaming of the beverage occurring as it passes through the infusing material. This is a significant problem where infusing is applied whereby the infusing material and the beverage are at different temperature. The present invention addresses this issue by creating a chilled environment where the beverage and the infusing material are contained at a substantially constant pressure and temperature.

It will be further appreciated that the font 10 of the present invention provides a simple and effective device for infusing a beverage, such as beer, with a flavoring prior to dispensing the beverage. This is achieved in a simple and effective manner and provides a clear and striking visual impression of the process as it is being performed. A consumer is able to see the infusing process and immediately taste the result, which has considerable advantages in terms of marketing and visual effect.

Further to this, the device of the present invention can be simply disassembled from cleaning and replacement of the infusing material as desired, and can operate simply and effectively in the absence of an infusing material, as a conventional beer font.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the end cap of the device uppermost.

It will be appreciated by those skilled in the art that many modifications and variations may be made to the methods of the invention described herein without departing from the spirit and scope of the invention.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A beverage dispensing device including:
a body configured to receive a supply of beverage from a source and having a pouring means mounted thereto for dispensing said beverage; and
an infusion chamber mounted to said body, the infusion chamber defining an enclosed space for receiving one or more infusion products;
wherein, the infusion chamber is in fluid communication with said body so as to receive the supply of beverage therefrom such that the beverage passes through said infusion chamber prior to being dispensed from the pouring means.

2. A beverage dispensing device according to claim 1, wherein:
the enclosed space of the infusion chamber is able to be maintained at a substantially constant temperature and pressure.

3. A beverage dispensing device according to claim 2, wherein:
a heat exchanger is provided to enable the enclosed space of the infusion chamber to be maintained at or close to a predetermined temperature.

4. A beverage dispensing device according to claim 3, wherein:
the heat exchanger is located wholly or partly within the body of the beverage dispensing device and/or the infusion chamber mounted to said body.

5. A beverage dispensing device according to claim 4, wherein:
the heat exchanger extends within the infusion chamber.

6. A beverage dispensing device according to claim 4, wherein:
the heat exchanger extends within the body of the device.

7. A beverage dispensing device according to claim 3, wherein:
the heat exchanger is associated with the body to chill the beverage prior to entering the infusion chamber.

8. A beverage dispensing device according to claim 3, wherein:
the heat exchanger includes one or more of a glycol plate, an ice bank chiller, the lines associated with said glycol plate or said ice bank chiller, or an in-line heat exchanger.

9. A beverage dispensing device according to claim 1, wherein:
the infusion chamber includes a tubular body made from a substantially transparent material.

10. A beverage dispensing device according to claim 9, wherein:
the tubular body of the infusion chamber is substantially cylindrical and is mounted to the body of the dispensing device so as to be positioned above said body of the dispensing device.

11. A beverage dispensing device according to claim 10, wherein:
the infusion chamber is configured to receive the supply of beverage via a delivery pipe that projects from the body of the dispensing device to extend within the infusion chamber and terminate adjacent an upper region of the infusion chamber.

12. A beverage dispensing device according to claim 11, wherein:
the delivery pipe is adapted to substantially fill the infusion chamber with beverage.

13. A beverage dispensing device according to claim 12, wherein:
the body has an outlet formed on an upper surface thereof for receiving the beverage present in the infusion chamber such that the beverage can be dispensed from the pouring means.

14. A beverage dispensing device according to claim 1, wherein:
the pouring means is a tap, nozzle, valve, plug, spout or a combination of said means suitable for pouring a beverage.

15. A beverage dispensing device according to claim 1, wherein:
the infusion chamber includes a secondary pouring means to enable dispensing of the beverage directly from the infusion chamber, the secondary pouring means located at or near an upper part of the infusion chamber.

16. A beverage dispensing device according to claim 1, wherein:
the infusion chamber includes a pressure relief valve for releasing air pressure from the infusion chamber.

17. A beverage dispensing device according to claim 16, wherein:
the pressure relief valve is a spring activated valve able to be pushed down to release air pressure from the infusion chamber.

18. A beverage dispensing device according to claim 17, wherein:
the pressure relief valve is associated with a secondary pouring means to enable a portion of the beverage to be poured directly from the infusion chamber via the secondary pouring means when the pressure relief valve is activated.

19. A beverage dispensing device according to claim 1, wherein:
the body of the dispensing device is configured for installation on a bar, a ledge or a platform suitable for dispensing a beverage.

20. A beverage dispensing device according to claim 1, wherein:
the body of the dispensing device is configured for replacing an existing beverage dispensing font or being located beside an existing beverage dispensing font or fonts.

21. A method of infusing a flavour into a beverage to be dispensed from a dispensing device comprising the steps of:
loading an infusion chamber associated with the dispensing device with an infusing material;
supplying the beverage to the infusion chamber at a predetermined pressure and temperature to substantially fill the infusion chamber such that the infusion chamber is maintained at or close to said predetermined pressure and temperature; and
releasing the beverage from the infusion chamber to be dispensed for consumption therefrom.

22. A method according to claim 21, wherein:
the step of releasing the beverage further comprises the step of:
opening a pouring means in fluid communication with the infusion chamber to facilitate dispensing of the beverage therefrom under the predetermined pressure.
